(19) United States
(12) Patent Application Publication
(10) Pub. No.: US 2007/0154772 A1
(43) Pub. Date: Jul. 5, 2007

(54) Plate structure for multi-slice fuel cell

(76) Inventors: Huang-Yi Chen, Taichung City (TW); Shuo-Jen Lee, Yonghe City (TW)

Correspondence Address: PRO-TECHTOR INTERNATIONAL SERVICES, 20775 NORADA CT., SARATOGA, CA, 95070, US

(21) Appl. No.: 11/644,357

(22) Filed: Dec. 22, 2006

(30) Foreign Application Priority Data
Dec. 22, 2005 (TW) 094145907

(51) Int. Cl. H01M 8/02

(52) U.S. Cl. 429/38; 428/167

(57) ABSTRACT

The present invention relates to a combined plate structure for a multi-slice fuel cell, which comprises a conducting substrate and a channel plate. The conducting substrate is in the form of a base, and the channel plate is in the form of a sheet having a channel therein. By assembling the conducting substrate and the channel plate together, a combined plate having a channel therein is accordingly formed such that the channel through the channel plate can be easily produced in a conventional mass manufacturing manner. The channel plate can be made of different materials based on various polarities so as to enhance corrosion resistance and electric conductivity thereof, thus lowering production cost and prolonging the service life of the fuel cell.

### BACKGROUND OF THE INVENTION

1. Field of the Invention

The present invention relates to a plate structure for a multi-slice fuel cell, and more particularly to a combined plate structure adopted for a small-size fuel cell that can greatly lower the production cost thereof.

2. Description of the Prior Arts

In general, an input fuel is applied to be an energy source of a fuel cell, and its reaction in the cell will transform a chemical energy into an electrical energy. Hence, as the energy source is kept inputting into the cell, ceaseless electricity is produced. The fuel cell has different terms based on various electrolyte therein, e.g., PAFC (phosphate fuel cell), MCFC (melt carbonate fuel cell), SOFC (solid oxide fuel cell), as well as PEMFC (proton exchange membrane fuel cell) and the like. Referring to FIG. 1, taking PEMFC as an example, two plates 10 and 11, between which A MEA (membrane electrode assembly) 12 is formed, are individually disposed at two sides of an oxy-hydrogen fuel cell, and includes inlets 101, 111 and outlets 102, 112, respectively. The plate 10 is a cathode and its inner side includes a channel 103 for oxygen flowing, yet the plate 11 is an anode and the inner side thereof includes a channel 113 for hydrogen flowing. As shown in FIG. 2, a stack structure of another PEMFC comprises two plates 20 and 21 having inlets 201, 211 and outlets 202, 212, respectively. The plate 20 is a cathode and its inner side includes a channel 203 for oxygen flowing, yet the plate 21 is an anode and the inner side thereof includes a channel 213 for hydrogen flowing. Two membrane electrode assemblies 22 and 23, between which a bipolar plate 24 is defined, are arranged between the plates 20 and 21. One side of the bipolar plate 24 in response to the plate 20 is an anode and includes a channel 241 therein, while another side of the bipolar 24 plate corresponding to the plate 21 is a cathode and includes a channel 242 therein. By means of a series connection, after electrochemical reaction past the membrane electrode assemblies 22 and 23, an electrical energy will produce, such that the fuel cell stack can be increasingly provided with a plurality of bipolar plates and membrane electrode assemblies so as to enhance its electrical energy in a series manner.

As far as a conventional fuel cell is concerned, if desiring to lower its manufacturing cost, the size must be small, e.g., an prior art bipolar plate occupies over half volume of the fuel cell, and the larger size is, the more efficient power and density are. However, such a bipolar plate is made of graphite, because graphite price is expensive, and the nature of graphite is too crisp to be used to make small-size bipolar plate, developing substitute material to manufacture small-size portable fuel cell is inevitable.

As far as a plate made of metal and composite material is concerned, although its strength is better than the graphite plate, the corrosion resistance and electric conductivity is quite poor. Furthermore, since the plate surface has to be provided with a hydrogen channel and an oxygen channel therein, the plate is manufactured in a mechanical milling, forging, electroforming, or etching manner and so on, nevertheless, because it is made of titanium or stainless steel material, its strong hardness will cause a processing tool damage, and a punch used in the forging process will be easily broken. Also, the production cost is over high due to complicated electroforming and etching processes.

The present invention has arisen to mitigate and/or obviate the afore-described disadvantages.

### SUMMARY OF THE INVENTION

The primary objective of the present invention is to provide a plate structure for a multi-slice fuel cell, which comprises a conducting substrate and a channel plate. The conducting substrate is in the form of a base, and the channel plate is in the form of a sheet having a channel therein. By assembling the conducting substrate and the channel plate together, a combined plate having a channel therein is accordingly formed such that the channel through the channel plate can be easily produced in a conventional mass manufacturing manner, thus lowering production cost.

Another objective of the present invention is to provide a plate structure for a multi-slice fuel cell, which by using assembly of the conducting substrate and the channel plate, a combined plate having a channel therein is accordingly finished. The channel plate can be made of different materials based on various polarities so as to enhance corrosion resistance and electric conductivity thereof, thus prolonging the service life of the fuel cell.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an exploded view of a conventional fuel cell;

FIG. 2 is an exploded view of a conventional fuel cell stack;

FIG. 3 shows an exploded view of a monopolar plate in accordance with the present invention;

FIG. 4 shows an assembly view of the monopolar plate in accordance with the present invention;

FIG. 5 shows an assembly cross sectional view of the monopolar plate in accordance with the present invention;

FIG. 6 is an exploded view of a monopolar plate in accordance with another embodiment of the present invention;

FIG. 7 is an assembly view of the monopolar plate in accordance with another embodiment of the present invention;

FIG. 8 is an assembly cross sectional view of the monopolar plate in accordance with another embodiment of the present invention;

FIG. 9 is an exploded view of an individual fuel cell in accordance with the present invention;

FIG. 10 shows an exploded view of a bipolar plate in accordance with the present invention;

FIG. 11 shows an assembly view of the bipolar plate in accordance with the present invention;

FIG. 12 shows an assembly cross sectional view of the bipolar plate in accordance with the present invention;

FIG. 13 is an exploded view of a bipolar plate in accordance with another embodiment of the present invention;

FIG. 14 is an assembly view of the bipolar plate in accordance with another embodiment of the present invention;

FIG. 15 is an assembly cross sectional view of the bipolar plate in accordance with another embodiment of the present invention;

FIG. 16 is an exploded view of a fuel cell stack in accordance with the present invention.

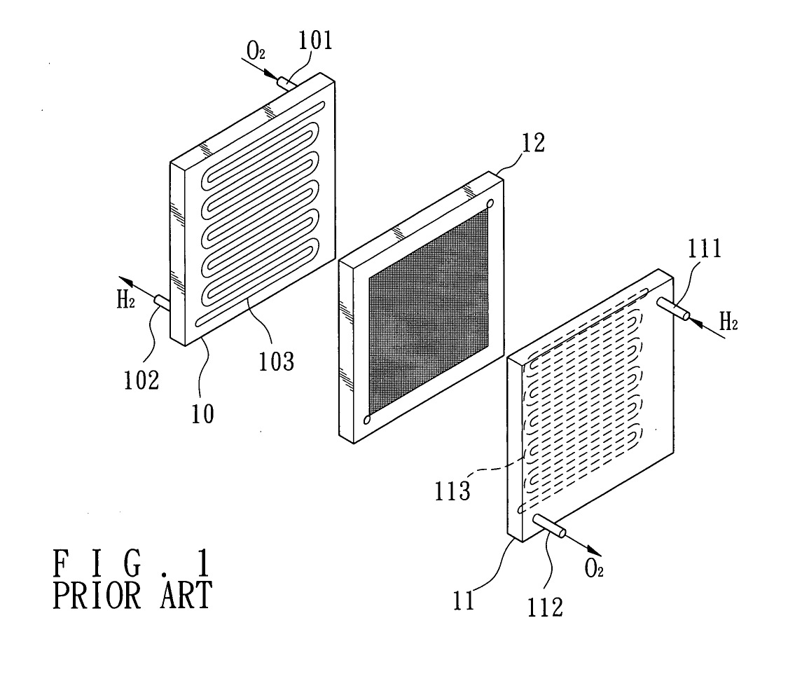

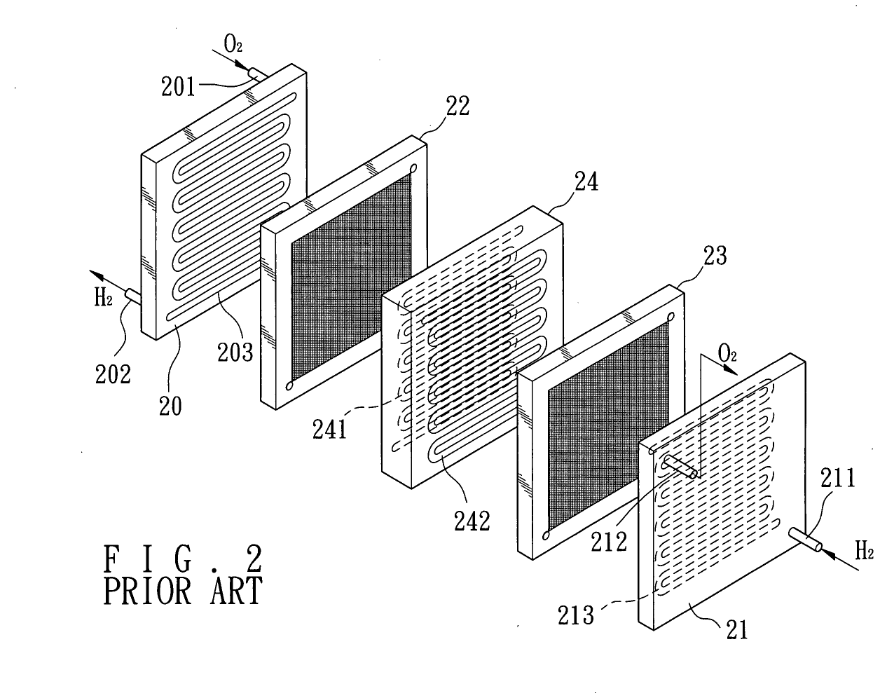

### DETAILED DESCRIPTION OF THE PREFERRED EMBODIMENT

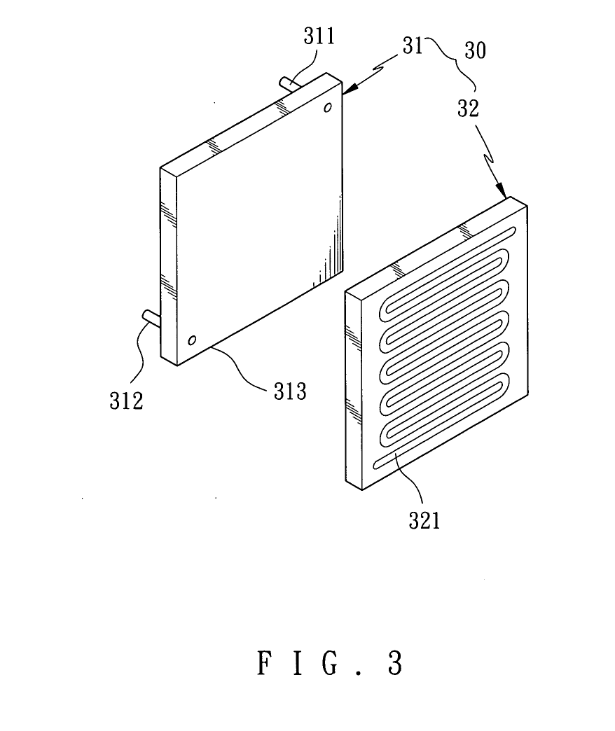

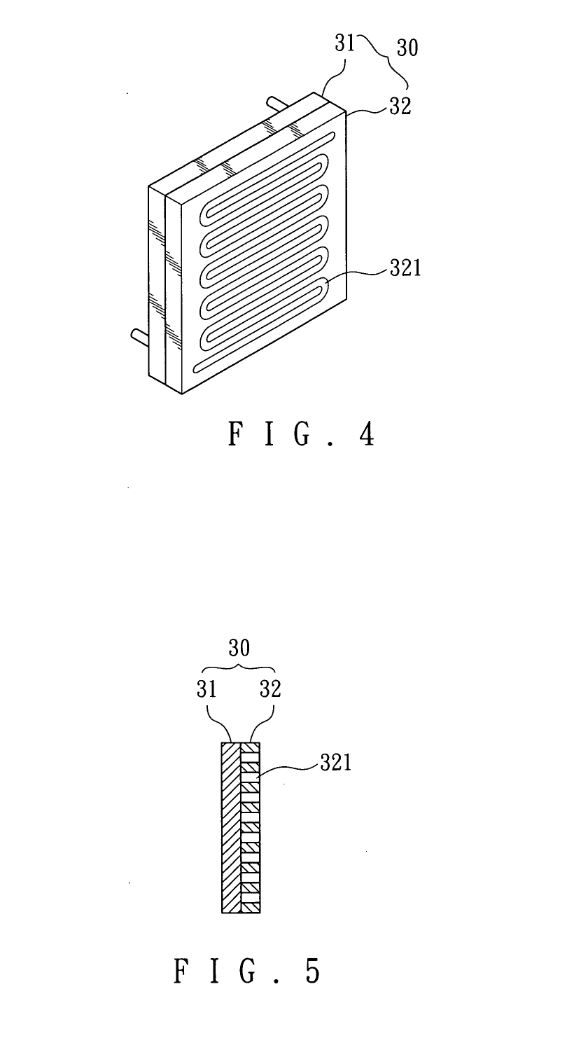

Referring to FIGS. 3-5, a monopolar plate 30 in accordance with the present invention is shown and comprises a conducting substrate 31 and a channel plate 32. The conducting substrate 31 is in the form of a base, at a side thereof is mounted an inlet 311 and an outlet 312 which are both provided with fuel, and at another side thereof is arranged a connecting surface 313 which is constructed in the form of a flat plate. A through channel 321 is disposed in an active zone of the channel plate 32 relative to a membrane electrode assembly, since the channel 321 is formed through the channel plate 32, it can be manufactured by a typical processing method, such as a punching process or the like. In other words, during punching process, the punch can directly cut past the workpiece to form a through channel 321 without causing plastic flow of the changed volume of the workpiece, thus the counterforce will not force onto the punch to occur damage. Depending on the application requirement, if the channel plate 32 is further secured to the plain connecting surface 313 of the conducting substrate 31 by welding or coating adhesive, the monopolar plate 30 having the channel 321 is finished.

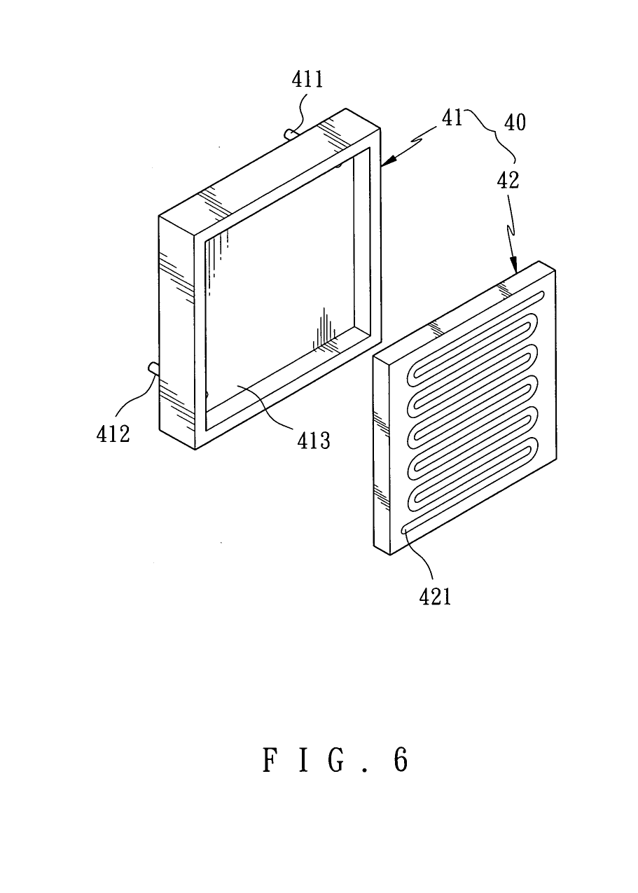

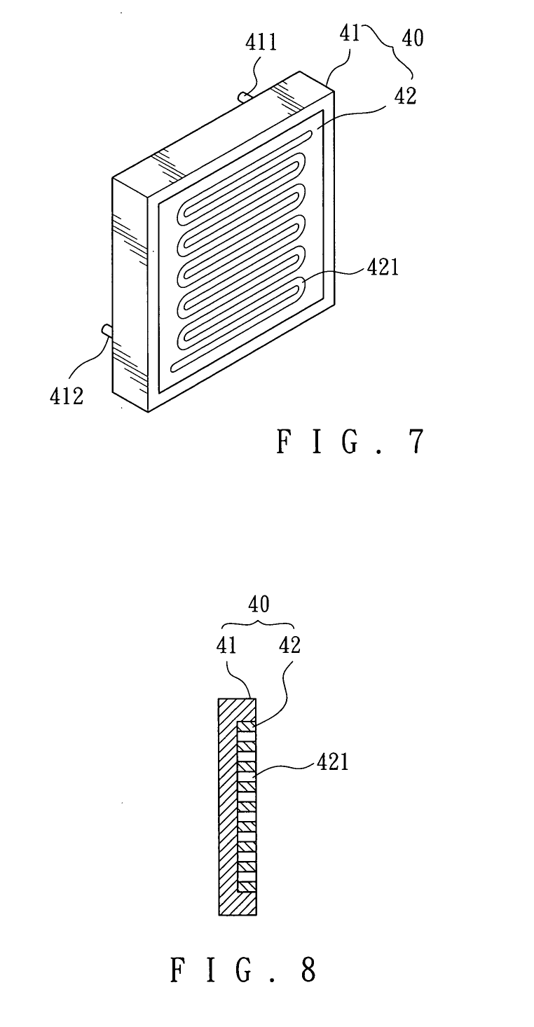

As shown in FIGS. 6-8, a monopolar plate 40 in accordance with the present invention is shown and comprises a conducting substrate 41 and a channel plate 42. The conducting substrate 41 is in the form of a base, at a side thereof is mounted an inlet 411 and an outlet 412 which are both provided with fuel, and at another side thereof is arranged a connecting surface 413 which is constructed in the form of a recessed plate. A through channel 421 is disposed in an active zone of the channel plate 42 relative to a membrane electrode assembly. Depending on the application requirement, if the channel plate 42 is further fixed to the recessed connecting surface 413 of the conducting substrate 41 by welding or coating adhesive, the monopolar plate 40 having the channel 421 is completed.

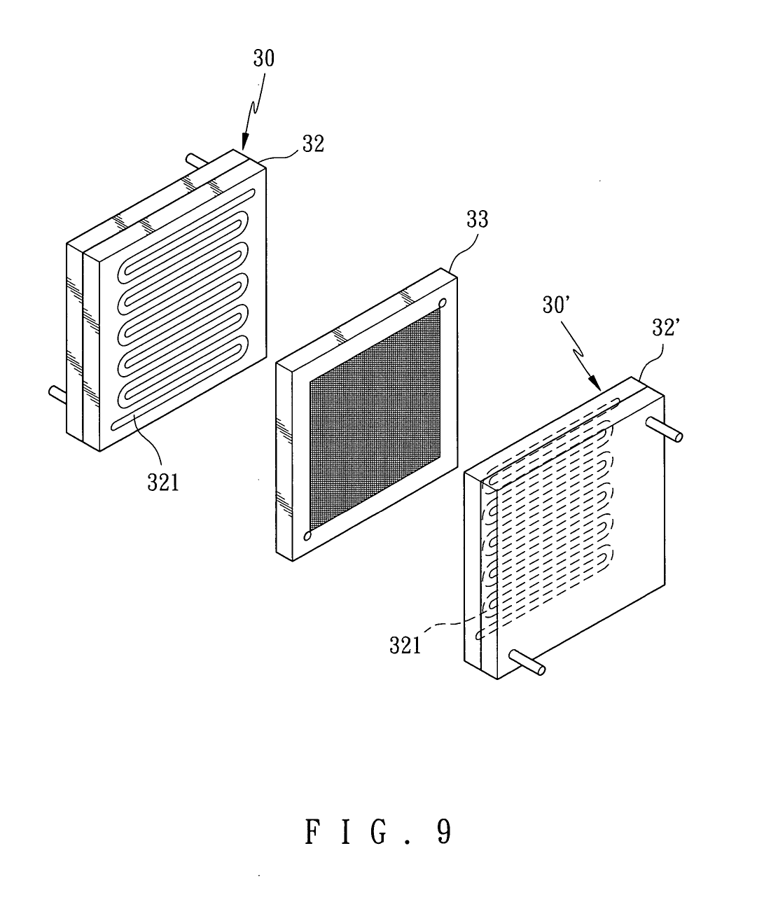

Referring further to FIG. 9, the finished plate 30 is a cathode and the channel 321 is disposed therein for the flow of oxygen, while a plate 30′ is an anode and a channel 321′ is defined therein for the flow of hydrogen. A MEA (membrane electrode assembly) 33 is formed between the plates 30 and 30′ for producing electrical energy through electrochemical reaction during transforming process of the chemical energy. Due to an oxidation in the active zone of the cathode plate 30 and a corrosion in the active zone of the anode plate 30′ will occur, hence the channel plate 32 of the cathode plate 30 has to be made of anti-oxidation material, yet the channel plate 32′ of the cathode plate 30′ has to be made of anti-corrosion material so as to prolong the service life of the fuel cell, such that the plate can be made of different materials based on various polarities.

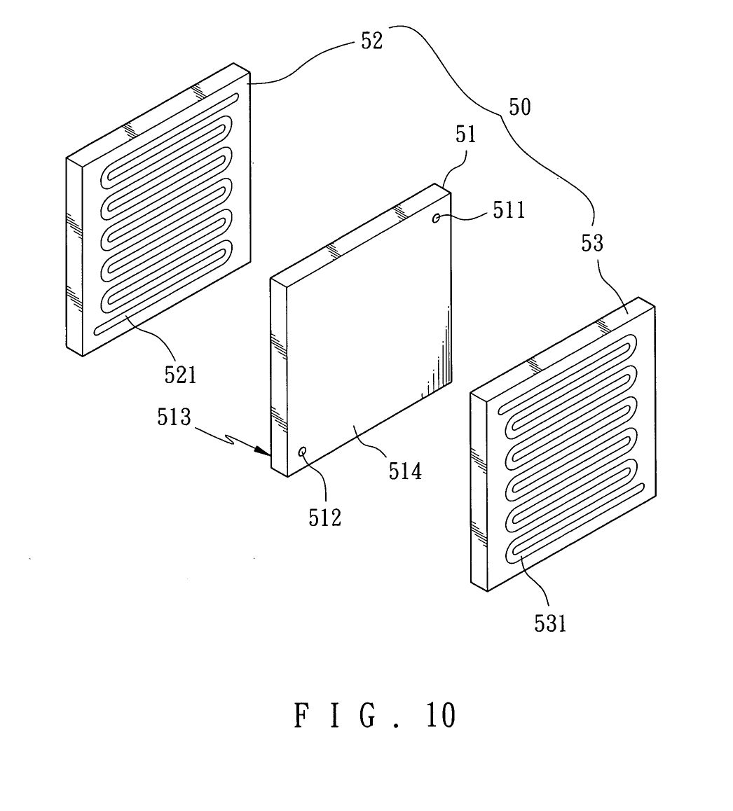

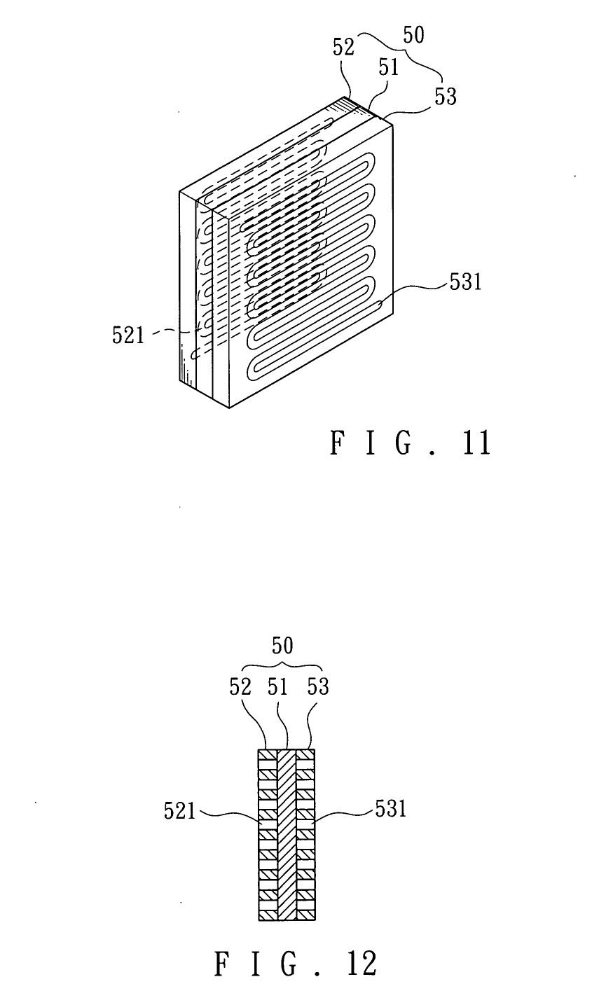

Referring to FIGS. 10-12, a bipolar plate 50 in accordance with the present invention comprises a conducting substrate 51, a first channel plate 52 and a second channel plate 53. The conducting substrate 51 is in the form of a base for the combination with the first and second channel plates 52 and 53, and includes a fuel inlet 511 and an oxygen inlet 512 thereon, at two sides thereof are respectively arranged two connecting surfaces 513 and 514, each being in the formed of a plain plate. Channels 521, 531 are individually formed in active zones of the channel plates 52, 53 with respect to a membrane electrode assembly, since the channels 521, 531 are correspondingly formed through the first and second channel plates 52, 53, they can be manufactured by a typical processing method, such as a punching process or the like. In other words, during punching process, the punch can directly cut past the workpiece to form the through channels 521 and 531 without causing plastic flow of the changed volume of the workpiece, thus the counterforce will not force onto the punch to occur damage such that the first and second channel plates 52, 53 can be easily produced in a mass manufacturing manner. Thereafter, the first and second channel plates 52 and 53 are correspondingly fixed to the plain connecting surfaces 513, 514 at two sides of the conducting substrate 51 by welding or coating adhesive, thus the monopolar plate 50 having the channels 521 and 531 is finished.

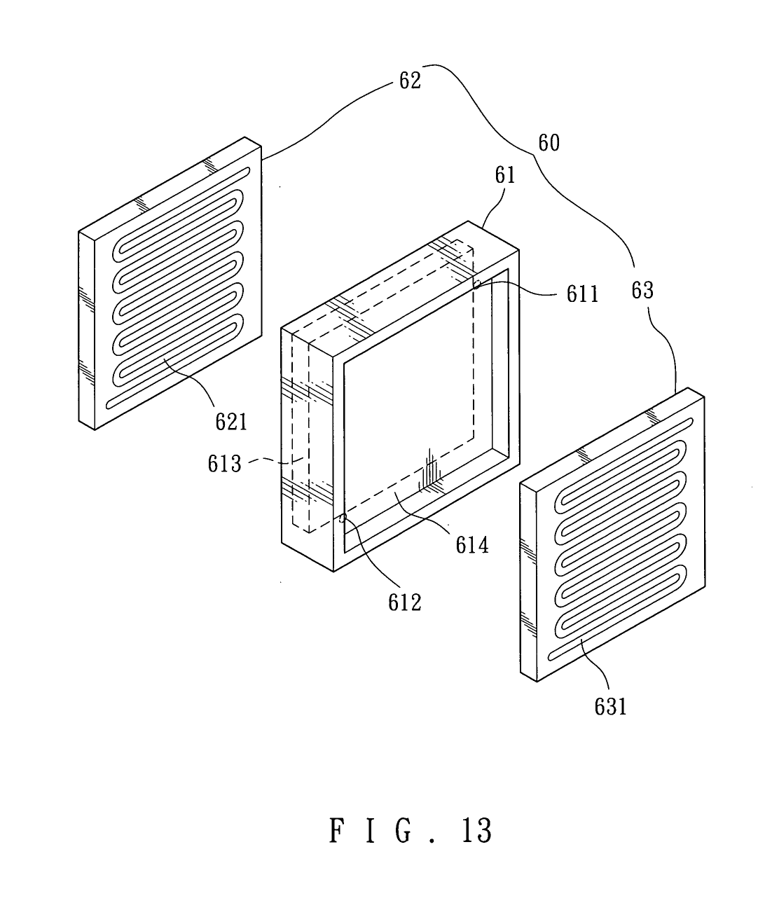

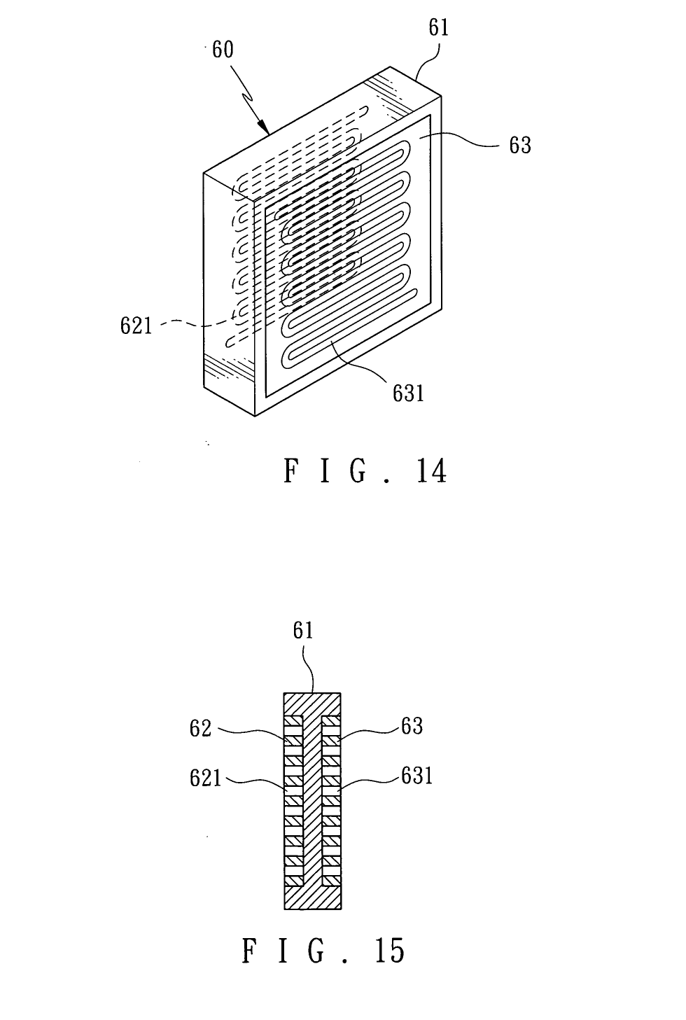

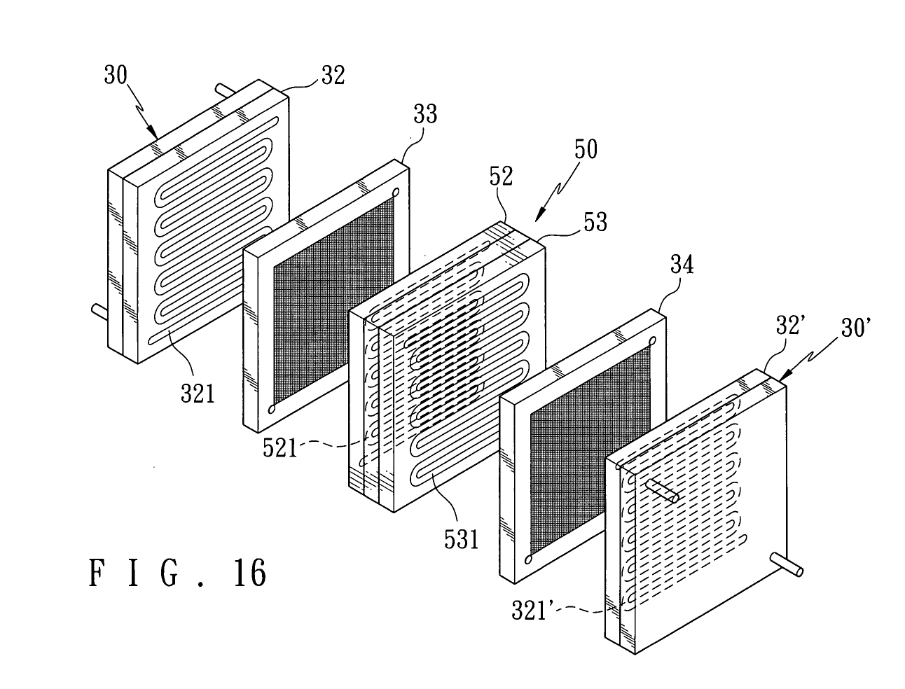

As shown in FIGS. 13-15, a bipolar plate 60 in accordance with the present invention also comprises a conducting substrate 61, a first channel plate 62 and a second channel plate 63. The conducting substrate 61 is in the form of a base for the combination with the first and second channel plates 62, 63, and includes a fuel inlet 611 and an oxygen inlet 612 thereon, at two sides thereof are respectively arranged two connecting surfaces 613 and 614, each being in the form of a recessed plate. Channels 621, 631 are individually formed in active zones of the channel plates 62, 63 relative to a membrane electrode assembly. Thereafter, the first and second channel plates 62, 63 are correspondingly secured to the recessed connecting surfaces 613, 614 of the conducting substrate 61 by welding or coating adhesive, thereby the monopolar plate 60 having the channels 621 and 631 is completed.

Referring further to FIG. 16, while applying the present invention to a fuel cell stack, the finished plate 30 is a cathode and the channel 321 is disposed therein for the flow of oxygen, while the plate 30′ is an anode and the channel 321′ is defined therein for the flow of hydrogen. Two MEAs (membrane electrode assemblies) 33 and 34, between which the bipolar plate 50 is defined, are formed between the plates 30 and 30′. The first channel plate 52 of one side of the bipolar plate 50 in response to the cathode plate 30 is an anode, and in the inner side thereof is mounted the channel 521 for the flow of hydrogen, yet the second channel plate 53 of another side of the bipolar plate 50 corresponding to the anode plate 30′ is an cathode, and in the inner side thereof is arranged the channel 531 for the flow of oxygen, thereby enabling to cause an electrical energy through electrochemical reaction during transforming process of the chemical energy. Due to oxidations of cathode surface of bipolar plate 50 and the active zone of the cathode plate 30 will occur, also, corrosions of anode surface of bipolar plate 50 and the active zone of the anode plate 30′ will easily form, hence the channel plate 32 of the cathode plate 30 and the second channel plate 53 of the bipolar channel 50 have to be made of anti-oxidation material, yet the channel plate 32′ of the anode plate 30′ and the first channel plate 52 of the bipolar plate 50 have to be made of anti-corrosion material so as to prolong the service life of the fuel cell, such that the plate can be made of different materials based on various polarities.

While we have shown and described various embodiments in accordance with the present invention, it should be clear to those skilled in the art that further embodiments may be made without departing from the scope of the present invention.

What is claimed is:

1. A combined plate structure for a multi-slice fuel cell comprising:
a conducting substrate being in the form of a base, at a side thereof being mounted an inlet and an outlet which are both provided with fuel, and at another side thereof being arranged a connecting surface;
a channel plate fixed to said connecting surface of said conducting substrate, and including a through channel therein for the flow of fuel.

2. The combined plate structure for a multi-slice fuel cell as claimed in claim 1, wherein said connecting surface of said conducting substrate is constructed in the form of a flat plate.

3. The combined plate structure for a multi-slice fuel cell as claimed in claim 1, wherein said connecting surface of said conducting substrate is constructed in the form of a recessed plate.

4. A combined plate structure for a multi-slice fuel cell comprising:
a conducting substrate being in the form of a base, and including fuel inlets thereon, at two sides thereof being arranged two connecting surfaces, respectively;
a first channel plate fixed to said connecting surface of one side of said conducting substrate, and in the inner side thereof being mounted a channel for the flow of fuel;
a second channel plate secured to said connecting surface of another side of said conducting substrate, and in the inner side thereof being mounted a channel for the flow of fuel.

5. The combined plate structure for a multi-slice fuel cell as claimed in claim 4, wherein each of said connecting surfaces of said conducting substrate is constructed in the form of a flat plate.

6. The combined plate structure for a multi-slice fuel cell as claimed in claim 4, wherein each of said connecting surfaces of said conducting substrate is constructed in the form of a recessed plate.

7. The combined plate structure for a multi-slice fuel cell as claimed in claim 4, wherein the material of said first channel plate is different from the material of said second channel plate.
